(19) United States
(12) Patent Application Publication
(10) Pub. No.: US 2021/0229523 A1
(43) Pub. Date: Jul. 29, 2021

(54) HEATING SYSTEM FOR VEHICLE COMPARTMENT

(71) Applicant: TOYODA GOSEI CO., LTD., Kiyosu-shi, Aichi-ken (JP)

(72) Inventors: Nobuhiro TERAI, Kiyosu-shi, Aichi-ken (JP); Koichi SUZUKI, Kiyosu-shi, Aichi-ken (JP); Chiharu TOTANI, Kiyosu-shi, Aichi-ken (JP); Yoshinori MASATSUGU, Kiyosu-shi, Aichi-ken (JP); Hiroshi IWATA, Kiyosu-shi, Aichi-ken (JP); Hiroto WATANABE, Kiyosu-shi, Aichi-ken (JP); Yasuhiro MARUTA, Kiyosu-shi, Aichi-ken (JP); Hisashi TAKAYA, Kiyosu-shi, Aichi-ken (JP)

(21) Appl. No.: 17/055,758

(22) PCT Filed: Feb. 27, 2019
(86) PCT No.: PCT/JP2019/007456

§ 371 Date: Nov. 16, 2020

(30) Foreign Application Priority Data
May 31, 2018 (JP) 2018-105714

(51) Int. Cl. B60H 1/02; B60H 1/00; B60H 1/22; B60R 13/02; B60N 2/75; B60N 2/90

(52) U.S. Cl. CPC B60H 1/02; B60H 1/00392; B60H 1/2225; B60R 2013/0287; B60N 2/79; B60N 2/90; B60R 13/0243

(57) ABSTRACT

Provided is a novel heating system for an electric vehicle.

A heating system for a vehicle compartment includes: a heat source storage chamber disposed below a vehicle compartment floor of an electric vehicle and configured to store at least one heat source element unit selected from an automotive battery, a motor, a converter, and an inverter; and a connection chamber configured to connect between the heat source storage chamber and the vehicle compartment. A heat exchange medium flows in the heat source storage chamber and the connection chamber. The heat source element unit and air in the vehicle compartment exchange heat with each other through the heat exchange medium.

### TECHNICAL FIELD

The present invention relates to a heating system for a vehicle compartment for heating an electric vehicle.

### BACKGROUND ART

In electric vehicles which have been notably widespread in recent years, an automotive battery such as a lithium ion secondary battery is mounted as a power source, and an electric motor driven by the power source is mounted as a prime mover.

An electric vehicle uses an automotive battery as a power source and does not burn petroleum fuel, and is thus more advantageous, in view of reduction of CO₂ emissions and the like, than an engined vehicle in which petroleum fuel is used as a power source and an engine is used as a prime mover. Meanwhile, an electric vehicle is considered to be less advantageous, in view of heating, than an engined vehicle that utilizes exhaust heat generated by burning petroleum fuel.

As a heating system for a vehicle compartment for heating an electric vehicle, for example, a heating system in which an automotive battery as a power source of an electric motor is used as a power source of an electric heater, is considered. However, this type of heating system for a vehicle compartment has a problem that, since the electric motor and the electric heater use a common automotive battery as the power source, if high energy is required for heating in winter or the like, a distance over which the electric vehicle runs is shortened.

In addition, as a heating system for a vehicle compartment in an electric vehicle, a heating system in which a power source for heating is different from the automotive battery is also suggested (for example, see Patent Literature 1).

Patent Literature 1 discloses a technique in which an electric vehicle has a heat storage tank, an electric heater is energized when an automotive battery is charged, and heat generated from the electric heater is stored in water in the heat storage tank. According to Patent Literature 1, the water in the heat storage tank is circulated in a heat exchanger when heating is performed, and heat from the heat exchanger is supplied to a vehicle compartment. Furthermore, Patent Literature 1 suggests that heat storage materials are stored in the heat storage tank and the heat storage materials are optimally disposed in the heat storage tank. Patent Literature 1 indicates, as effects of such a heat storage tank, an effect of increasing an amount of stored heat while minimizing the volume of the heat storage tank, and an effect of efficiently storing heat in the heat storage materials and efficiently dissipating heat from the heat storage materials since the heat storage materials are stored with intervals therebetween.

### CITATION LIST

### Patent Literature

Patent Literature 1: JP2013-256255(A)

### SUMMARY OF INVENTION

### Technical Problem

However, in a case where the heat storage tank as disclosed in Patent Literature 1 is disposed, a problem arises that a heating system for a vehicle compartment in an electric vehicle has a large size, and the heating system for the vehicle compartment becomes very heavy, and fuel efficiency of the electric vehicle thus deteriorates.

The present invention has been made in view of the aforementioned circumstances, and an object of the present invention is to provide a novel heating system for an electric vehicle.

### Solution to Problem

In order to solve the aforementioned problem, a heating system for a vehicle compartment according to the present invention includes: a heat source storage chamber disposed below a vehicle compartment floor of an electric vehicle and configured to store at least one heat source element unit selected from an automotive battery, a motor, a converter, and an inverter; and a connection chamber configured to connect between the heat source storage chamber and the vehicle compartment. A heat exchange medium flows in the heat source storage chamber and the connection chamber. The heat source element unit and air in the vehicle compartment exchange heat with each other through the heat exchange medium.

### Advantageous Effects of Invention

The heating system for a vehicle compartment according to the present invention is a novel heating system for an electric vehicle.

### BRIEF DESCRIPTION OF DRAWINGS

FIG. 1 is a top view schematically showing a heat supply element of embodiment 1;

FIG. 2 schematically illustrates a relationship between an occupant and the heat supply element of embodiment 1;

FIG. 3 schematically illustrates a relationship between an occupant and the heat supply element of embodiment 1;

FIG. 4 schematically illustrates a heat supply element of embodiment 2;

FIG. 5 schematically illustrates a heat supply element of embodiment 3;

FIG. 6 schematically illustrates a heat supply element of embodiment 4;

FIG. 7 schematically illustrates a duct blowing portion of a heat supply element according to embodiment 5;

FIG. 8 schematically illustrates the duct blowing portion of the heat supply element according to embodiment 5;

FIG. 9 schematically illustrates a heating system for a vehicle compartment according to embodiment 6;

FIG. 10 schematically illustrates a heating system for a vehicle compartment according to embodiment 7;

FIG. 11 schematically illustrates a heating system for a vehicle compartment according to embodiment 8;

FIG. 12 schematically illustrates a heating system for a vehicle compartment according to embodiment 9;

FIG. 13 schematically illustrates a heating system for a vehicle compartment according to embodiment 10;

FIG. 14 schematically illustrates a heating system for a vehicle compartment according to embodiment 11;

FIG. 15 schematically illustrates a porous tubular formed product according to embodiment 12; and

FIG. 16 schematically illustrates a tubular member of embodiment 13.

### DESCRIPTION OF EMBODIMENTS

A heating system for a vehicle compartment according to the present invention will be described below.

The heating system for a vehicle compartment according to the present invention includes a heat source storage chamber and a connection chamber. Among them, the heat source storage chamber is disposed below a vehicle compartment floor of an electric vehicle and stores a heat source element unit. The heat source storage chamber preferably has such a shape as to demarcate its inside from the outside except that the heat source storage chamber connects to the connection chamber and to a predetermined path as necessary. The heat source storage chamber has, for example, a box-like shape or a bottomed duct-like shape. In other words, the heat source storage chamber is preferably a semi-hermetically sealed space.

The heat source element unit is stored in the heat source storage chamber. The heat source element unit is selected from an automotive battery, a motor, a converter, and an inverter each of which generates heat when operated. Therefore, the heat source element unit functions as a heat source in addition to having a primary function. The heat source element unit is stored in the heat source storage chamber, and, thus, is thermally insulated from the outside. Therefore, in the heating system for a vehicle compartment according to the present invention, heat generated by the heat source element unit is not easily dissipated to the outside.

The connection chamber connects between the above-described heat source storage chamber and a vehicle compartment. Furthermore, a heat exchange medium flows in the above-described heat source storage chamber and the connection chamber. Therefore, the connection chamber is considered to be a supply path for supplying heat generated by the heat source element unit from the heat source storage chamber to the vehicle compartment. More specifically, heat generated by the heat source element unit is considered to be transferred to the heat exchange medium in the heat source storage chamber, and be supplied together with the heat exchange medium to the vehicle compartment. In other words, the heat source element unit and the heat exchange medium are considered to exchange heat with each other in the heat source storage chamber, and the heat exchange medium and air are considered to exchange heat with each other in the vehicle compartment. The heat source element unit and the heat exchange medium directly or indirectly exchange heat with each other. That is, the heat source element unit and the heat exchange medium are in direct contact with each other or in contact with each other through another member. Also in a case where the heat source element unit and the heat exchange medium are in contact with each other through, for example, another member such as a container, the heat source element unit and the heat exchange medium are considered to indirectly exchange heat with each other.

Similarly, air in the vehicle compartment and the heat exchange medium directly or indirectly exchange heat with each other.

In the heating system for a vehicle compartment according to the present invention, the vehicle compartment is heated by utilizing exhaust heat of the heat source element unit. The heat source element units, i.e., an automotive battery, a motor, a converter, and an inverter are operated and generate heat when the electric vehicle is driven. The vehicle compartment is required to be heated mainly when the electric vehicle is driven. Therefore, in the heating system for a vehicle compartment according to the present invention, the heat source element unit is considered to act as a heat source when heating is required, and the heat from the heat source is considered to be supplied to the heating system for the vehicle compartment. Therefore, the heating system for a vehicle compartment according to the present invention does not necessarily require a mechanism for storing heat such as, for example, the heat storage tank as disclosed in Patent Literature 1. Therefore, the heating system for a vehicle compartment according to the present invention has a size and a weight that are reduced as compared with a conventional heating system for a vehicle compartment for which the heat storage tank is essential. Needless to say, the heating system for a vehicle compartment according to the present invention has a heat storage tank as appropriate. However, also in this case, in the heating system for a vehicle compartment according to the present invention, a volume required for the heat storage tank is reduced as compared with a conventional heating system for a vehicle compartment.

The heat source storage chamber is disposed below a vehicle compartment floor of an electric vehicle. Therefore, the heating system for a vehicle compartment according to the present invention is proper for heating a portion where an occupant feels comfortable when the vehicle compartment is heated, that is, the lower side portion of the vehicle compartment. That is, the connection chamber also preferably connects to the vehicle compartment at a position that is relatively close to the vehicle compartment floor and that is near a seat of an occupant. Specifically, a part of the connection chamber is preferably integrated with or disposed near a center console box, a door trim of a side door or a back door, or a vehicle compartment floor, as described below.

As the heat exchange medium, gas such as air is used or liquid such as water or antifreeze is used. For reference, the antifreeze is, for example, an antifreeze containing ethylene glycol, a rust inhibitor, a defoaming agent, or the like. In a case where a liquid heat exchange medium is used, an excellent heat exchange efficiency of the liquid heat exchange medium is advantageously used to efficiently recover heat of the heat source element unit. Meanwhile, in a case where air is used as the heat exchange medium, use of air is advantageous in that the heat exchange medium is inexhaustibly taken in from the outside, there is no concern for liquid leakage or the like, and a path in which the heat exchange medium flows is simplified to reduce cost.

Furthermore, in a case where air is used as the heat exchange medium, the heat exchange medium flowing in the connection chamber is directly blown into the vehicle compartment. In this case, heat loss is advantageously reduced as compared with a case where heat exchange is repeated, and the connection chamber is advantageously formed into a simple shape such as a simple tubular shape. In this case, the vehicle compartment is heated by heat exchange between air originally existing in the vehicle compartment and air blown into the vehicle compartment.

In a case where a liquid heat exchange medium is used, the heat exchange medium flowing in the connection chamber is not blown directly into the vehicle compartment, unlike a case where air is used as the heat exchange medium. However, for example, the liquid heat exchange medium is caused to exchange heat with a vehicle compartment floor, a door trim, a center console box, or the like. Air in the vehicle compartment exchanges heat with, for example, the vehicle compartment floor heated by the heat exchange, and, thus, air in the vehicle compartment is heated and the vehicle compartment is heated

In the heating system for a vehicle compartment according to the present invention, a gaseous heat exchange medium and a liquid heat exchange medium are used in combination or one of a gaseous heat exchange medium and a liquid heat exchange medium is used.

The heat exchange medium in the heating system for a vehicle compartment according to the present invention is allowed to exchange heat with air in the vehicle compartment through another heating device having a thermoelectric conversion module. That is, heat generated by the heat source element unit is supplied to the other heating device through the heat exchange medium. In other words, the heating system for a vehicle compartment according to the present invention is usable as an auxiliary heating system of the other heating device. Hereinafter, the other heating device is referred to as an air conditioner for a vehicle compartment as appropriate.

In a case where the heating system for a vehicle compartment according to the present invention is used as an auxiliary heating system of an air conditioner for a vehicle compartment, a thermoelectric conversion module of the air conditioner for the vehicle compartment directly or indirectly exchanges heat with the heat exchange medium, and further directly or indirectly exchanges heat with air in the vehicle compartment. Therefore, the heat exchange medium is also considered to indirectly exchange heat with air in the vehicle compartment.

In this case, exhaust heat of the heat source element unit is utilized as a part of a heat amount required for the air conditioner for the vehicle compartment, and, consequently, power required for thermoelectric conversion module is reduced. In this case, although any thermoelectric conversion module is usable, examples of the thermoelectric conversion module include a PTC (positive temperature coefficient) heater using a PTC semiconductor, an electric heater using an electric heating wire, and a thermoelectric conversion element such as a Peltier device.

The heating system for a vehicle compartment according to the present invention is structured to merely have the heat source storage chamber, the connection chamber, and the heat exchange medium, or structured to have other elements in addition thereto. Examples of the other elements include, but are not limited to, a transport unit such as a pump and a blower for transporting the heat exchange medium, a storage tank for storing the heat exchange medium, and the heat source element unit, the thermoelectric conversion module, the air conditioner for a vehicle compartment, the vehicle compartment floor, the door trim, and the center console box as described above.

The heating system for a vehicle compartment according to the present invention is considered to have a heat recovery element and a heat supply element. The heat recovery element is considered to recover heat of the heat source element unit in the heating system for a vehicle compartment according to the present invention, and corresponds to the heat source storage chamber and, in some cases, to a part of the connection chamber connecting to the heat source storage chamber. The heat supply element is considered to supply, to a vehicle compartment, heat recovered by the heat exchange medium in the heat source storage chamber, in the heating system for a vehicle compartment according to the present invention, and corresponds to a part or the entirety of the connection chamber. The heat exchange medium flows or moves between the heat recovery element and the heat supply element to function to recover heat from the heat source element unit and supply the recovered heat to a vehicle compartment.

The heating system for a vehicle compartment according to the present invention will be described below by using a specific example.

### Embodiment 1

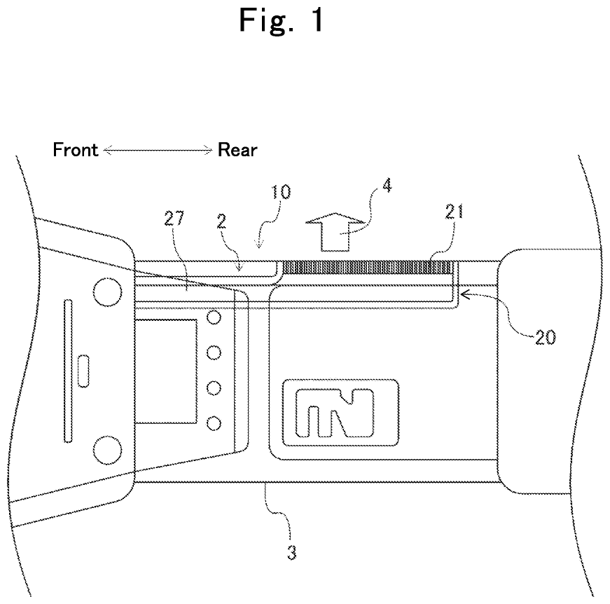

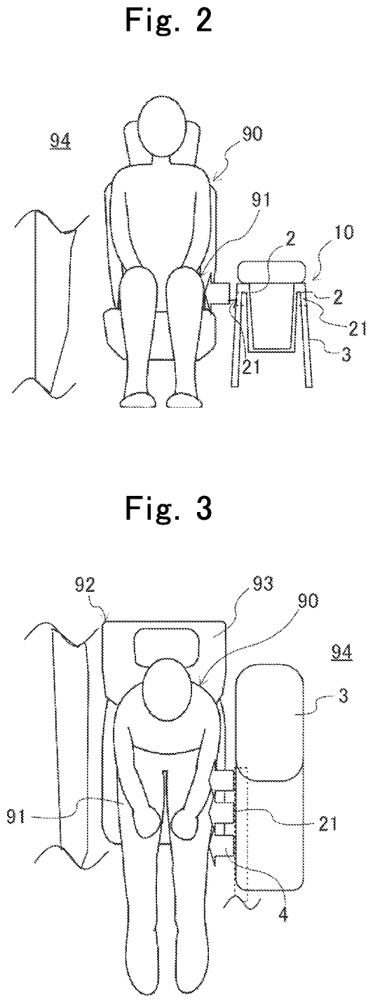

In embodiment 1, a connection chamber in the heating system for a vehicle compartment according to the present invention will be mainly described. The connection chamber connects between a heat source storage chamber and a vehicle compartment, and forms a part or the entirety of the above-described heat supply element. FIG. 1 is a top view schematically showing a heat supply element of embodiment 1. FIG. 2 and FIG. 3 schematically illustrate a relationship between an occupant and the heat supply element of embodiment 1. FIG. 2 illustrates the heat supply element of embodiment 1 as viewed from the front side in the vehicle running direction. FIG. 3 illustrates the heat supply element of embodiment 1 as viewed from the upper side. Hereinafter, upper and lower represent the upper side and the lower side in the vertical direction, and front, rear, left, and right represent the front, the rear, the left, and the right in the vehicle running direction.

The heat supply element 10 of embodiment 1 is implemented by the connection chamber in the heating system for a vehicle compartment according to the present invention, and specifically has a duct portion 2. In addition, the heat supply element 10 of embodiment 1 includes a console box 3 and a not-illustrated transport unit. For reference, the transport unit is a blower and transports air 4 as a heat exchange medium from a not-illustrated heat source storage chamber toward the duct portion 2.

As shown in FIG. 1, the duct portion 2 includes a duct blowing portion 20 and a duct general portion 27. The duct general portion 27 and the duct blowing portion 20 are integrated with each other, and are further integrated with the console box 3. Specifically, the duct blowing portion 20 is an almost tubular member having a slit-like blowing opening 21, and is integrated with one end portion of the duct general portion 27 in the axial direction. The other end portion (not illustrated) of the duct general portion 27 in the axial direction connects to the not-illustrated heat source storage chamber, which is not illustrated. The duct blowing portion 20 is fixed integrally to the right side wall of the console box 3.

As shown in FIG. 2, the heat supply element 10 of embodiment 1 has two duct portions 2, which are not shown in FIG. 1 and FIG. 3 described below. The duct blowing portion 20 of the other duct portion 2 is fixed integrally to the left side wall of the console box 3.

In the heat supply element 10, the air 4 as a heat exchange medium flows. The air 4 is heated in the not-illustrated heat source storage chamber by heat exchange with a not-illustrated heat source element unit, reaches the duct portions 2 which are the connection chambers, passes through the duct general portions 27, and is blown via the duct blowing portions 20 from the blowing openings 21 to the right and the left of the console box 3, that is, toward a driver's seat and a front passenger seat.

As shown in FIG. 2, the blowing opening 21 is disposed at a position that almost corresponds to a thigh portion 91 of an occupant 90 in the up-down direction. As shown in FIG. 3, the blowing opening 21 has a shape that is elongated in the front-rear direction. That is, the blowing opening 21 is disposed at a position at which the entirety of the thigh portion 91 of the occupant 90 is almost covered also in the front-rear direction.

Therefore, the heat supply element 10 of embodiment 1 mainly warms the thigh portion 91 of the occupant 90 by the heating. The air 4 blown out from the blowing opening 21 has a flow rate of about 1 to 2 m/second in the heat supply element 10 of embodiment 1.

Warming of the back and the thigh portion 91 of a human body is considered to be effective in a cold state. That is, mainly warming the back and the thigh portion 91 of the occupant 90 is considered to be efficient in order to allow the occupant 90 to feel warm by a smaller amount of heat. The back is covered by a backrest 93 of a seat 92 and heated by a not-illustrated seat heater as appropriate. Therefore, the occupant 90 is considered to be more likely to feel cold at the thigh portion 91 than at the back. In the heat supply element 10 of embodiment 1, the warmed air 4, i.e., warm air is blown to the thigh portion 91 of the occupant 90 in a concentrated manner. Therefore, in the heat supply element 10 of embodiment 1, a vehicle compartment 94 is considered to be efficiently heated at such a temperature that the occupant 90 feels comfortable by a relatively small amount of heat recovered from the heat source element unit.

The heat supply element 10 of embodiment 1 has two duct portions 2. However, in the heating system for a vehicle compartment according to the present invention, the heat supply element 10 is allowed to merely have one of the duct portions 2. That is, in the heating system for a vehicle compartment according to the present invention, the heat supply element 10 heats both the occupant 90 seated in the driver's seat and the occupant 90 seated in the front passenger seat, or heats one of the occupants 90 seated in the driver's seat and the front passenger seat. The same applies to embodiments described below.

Furthermore, in the heating system for a vehicle compartment according to the present invention, the heat supply element 10 does not necessarily have the console box 3. Alternatively, in the heating system for a vehicle compartment according to the present invention, the heat supply element 10 has an interior member other than the console box 3. For example, the heating system for a vehicle compartment according to the present invention has a tower-shaped interior member instead of the console box 3. In this case, the duct portion 2 is integrated with the tower-shaped interior member at a proper position as appropriate, whereby the blowing opening 21 of the duct portion 2 is positioned at a height position corresponding to the height of the thigh portion 91 of the occupant 90. Also in this case, similarly to the heat supply element of embodiment 1, the vehicle compartment 94 is efficiently heated at such a temperature that the occupant 90 feels comfortable by a relatively small amount of heat recovered from the heat source element unit.

### Embodiment 2

In embodiment 2, another example of the heat supply element in the heating system for a vehicle compartment according to the present invention will be described.

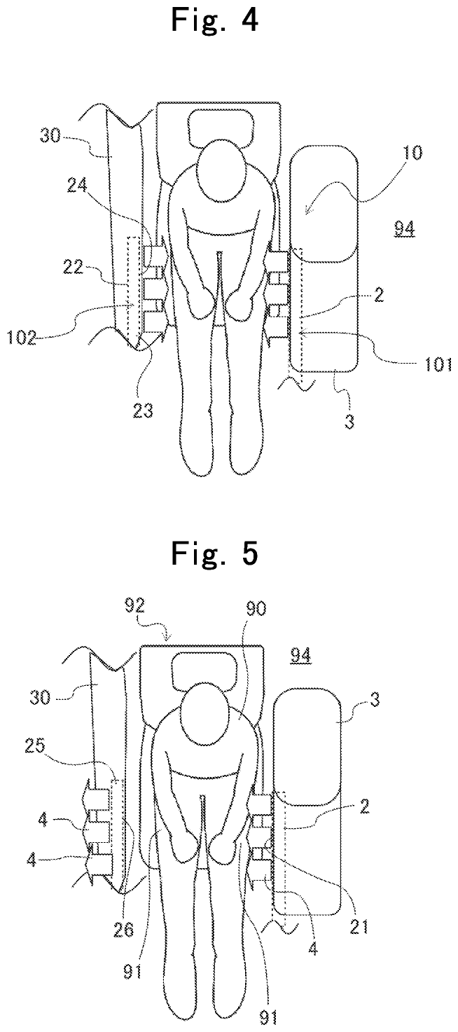

FIG. 4 schematically illustrates a heat supply element of embodiment 2.

Specifically, a heat supply element 10 of embodiment 2 includes a first heat supply element 101 that has the console box 3, the duct portion 2, and the not-illustrated transport unit similar to the heat supply element 10 of embodiment 1, and a second heat supply element 102 that has a door trim 30 of the side door and a second duct portion 22. In the second heat supply element 102, the second duct portion 22 connects to a not-illustrated heat source storage chamber similarly to the duct portion 2 in the first heat supply element 101.

The second duct portion 22 has a second duct blowing portion 23 integrated with the door trim 30. Specifically, the second duct portion 22 includes the second duct blowing portion 23 having a second blowing opening 24 similarly to the duct portion 2 in the first heat supply element 101. The second blowing opening 24 is disposed so as to oppose the blowing opening 21 in the first heat supply element 101. Hereinafter, the duct portion 2 in the first heat supply element 101 is referred to as a first duct portion 2 and the blowing opening 21 of the first duct portion 2 is referred to as a first blowing opening 21, and the duct portion 2 and the blowing opening 21 are distinguished from the second duct portion 22 and the second blowing opening 24, respectively, as necessary.

Similarly to the first blowing opening 21, the second blowing opening 24 connects to the heat source storage chamber through the second duct portion 22, and the air 4 as a heat exchange medium flows thereinside. Therefore, warm air is blown out also from the second blowing opening 24 toward the thigh portion 91 of the occupant 90.

In the heat supply element 10 of embodiment 2, warm air is blown out from the first blowing opening 21 and the second blowing opening 24, whereby the thigh portion 91 of the occupant 90 is heated from both the left and right sides. Therefore, the heat supply element 10 of embodiment 2 more efficiently warms the occupant 90. Consequently, the vehicle compartment 94 is efficiently heated at such a temperature that the occupant 90 feels comfortable.

The heat supply element 10 of embodiment 2 includes the first heat supply element 101 and the second heat supply element 102. However, in the heating system for a vehicle compartment according to the present invention, the heat supply element 10 is allowed to merely have the second heat supply element 102. That is, the heating system for a vehicle compartment according to the present invention has the first duct portion 2 integrated with the console box 3, has the second duct portion 22 integrated with the door trim 30, or has both the first duct portion 2 integrated with the console box 3 and the second duct portion 22 integrated with the door trim 30.

### Embodiment 3

In embodiment 3, another example of the heat supply element in the heating system for a vehicle compartment according to the present invention will be described.

FIG. 5 schematically illustrates a heat supply element of embodiment 3.

The heat supply element 10 of embodiment 3 has the door trim 30 of the side door and an introduction duct portion 25 in addition to the console box 3, the duct portion 2, and the not-illustrated transport unit similar to those of the heat supply element 10 of embodiment 1.

The introduction duct portion 25 has an introduction opening 26, connects to a heat source storage chamber (not shown) of a heat recovery element 15 described below, takes in air in the vehicle compartment 94, and supplies the air to the heat source storage chamber. That is, the heat supply element 10 of embodiment 3 allows air in the vehicle compartment 94 to circulate between the heat source storage chamber and the vehicle compartment 94. Thus, embodiment 3 is advantageous in that heat loss is reduced, and the vehicle compartment 94 is efficiently warmed.

The introduction opening 26 of the introduction duct portion 25 and the blowing opening 21 of the duct portion 2 have almost the same shape, and are disposed at almost the same position in the up-down direction and the front-rear direction. That is, the introduction opening 26 of the introduction duct portion 25 and the blowing opening 21 of the duct portion 2 oppose each other. Therefore, warm air blown out from the blowing opening 21 flows toward the introduction opening 26 in the vehicle compartment 94. The thigh portion 91 of the occupant 90 seated in the seat 92 is positioned between the blowing opening 21 and the introduction opening 26. Therefore, the heat supply element 10 of embodiment 3 efficiently warms the thigh portion 91 of the occupant 90. In other words, in the heat supply element 10 of embodiment 3, the directivity of warm air blown out from the blowing opening 21 is enhanced in the vehicle compartment 94, whereby the vehicle compartment 94 is efficiently heated at such a temperature that the occupant 90 feels comfortable by a relatively small amount of heat recovered from the heat source element unit.

### Embodiment 4

In embodiment 4, another example of the heat supply element in the heating system for a vehicle compartment according to the present invention will be described.

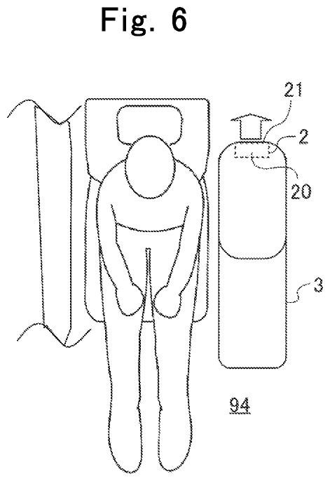

FIG. 6 schematically illustrates a heat supply element of embodiment 4.

The heat supply element 10 of embodiment 4 includes the console box 3, the duct portion 2, and the not-illustrated transport unit similarly to the heat supply element 10 of embodiment 1 but is different from the heat supply element 10 of embodiment 1 in that the blowing opening 21 of the duct blowing portion 20 faces toward a rear seat in embodiment 4.

The heat supply element 10 of embodiment 4 efficiently heats the vehicle compartment 94 at such a temperature that the occupant 90 seated in the rear seat feels comfortable.

### Embodiment 5

In embodiment 5, another example of the heat supply element in the heating system for a vehicle compartment according to the present invention will be described. Specifically, a duct blowing portion of the heat supply element will be described in embodiment 5.

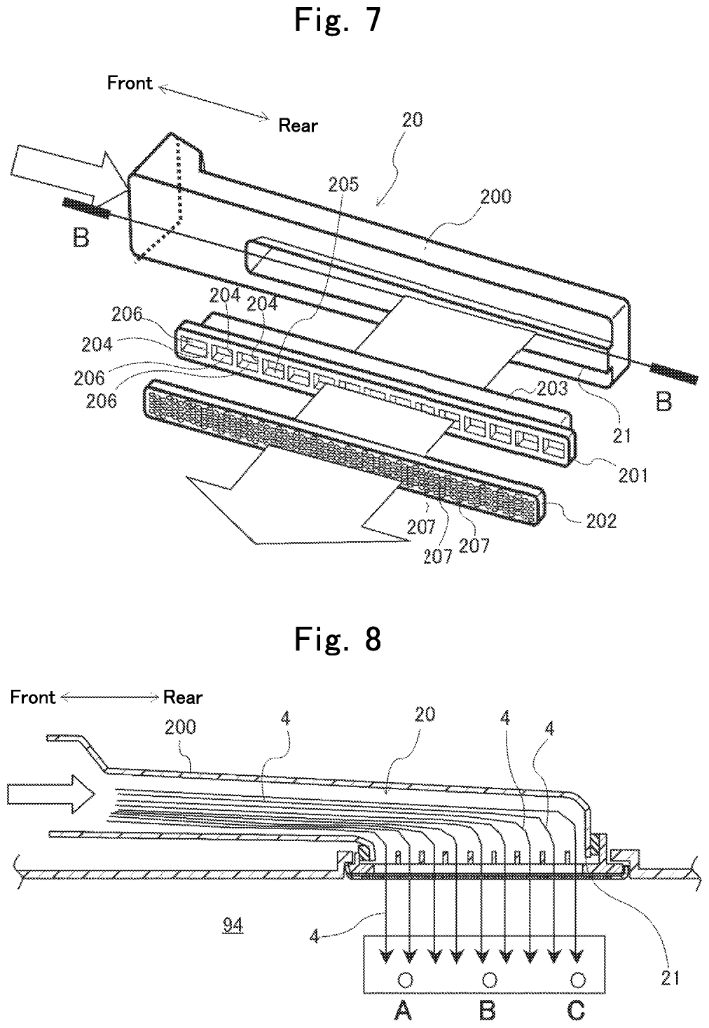

FIG. 7 and FIG. 8 schematically illustrate the duct blowing portion of the heat supply element according to embodiment 5. FIG. 7 illustrates the duct blowing portion in a disassembled state and FIG. 8 illustrates a cross-section of the duct blowing portion taken along positions B-B in FIG. 7.

In the heat supply element 10 of embodiment 5, the duct blowing portion 20 is a member which has an almost tubular shape and includes a slit-like blowing opening 21. The duct blowing portion 20 includes: a tubular base body 200 having the blowing opening 21; a guide fin member 201; and a porous plate 202. The guide fin member 201 and the porous plate 202 are mounted in the blowing opening 21 of the base body 200. The guide fin member 201 has a frame 203 and a plurality of fin parts 204. The frame 203 includes a slit-like opening 205 having the same longitudinal direction as the blowing opening 21, and the fin parts 204 are integrated with the frame 203. More specifically, the fin parts 204 are each plate-shaped, are arranged at almost predetermined regular intervals along the longitudinal direction of the frame 203, and extended over the opening 205 of the frame 203. Therefore, the opening 205 of the frame 203 is considered to be sectioned into a plurality of parts by the fin parts 204. In other words, the guide fin member 201 has a plurality of small openings 206 sectioned by the fin parts 204, and the small openings 206 are arranged at predetermined intervals along the longitudinal direction of the blowing opening 21.

The porous plate 202 is mounted on the outer side of the guide fin member 201. That is, the above-described members, i.e., the base body 200, the guide fin member 201, and the porous plate 202 are arranged in order, respectively, in the warm-air blowing forward direction.

The porous plate 202 has a large number of very small openings 207. The size of each of the very small openings 207 of the porous plate 202 is much smaller than the size of each of the small openings 206 of the guide fin member 201. The number of the very small openings 207 of the porous plate 202 is much greater than the number of the small openings 206 of the guide fin member 201. In the heat supply element 10 of embodiment 5, each of the small openings 206 of the guide fin member 201 has an opening size of about 8 to 40 mm, and a distance (that is, the width of the fin part 204) between the small openings 206 adjacent to each other is about 2 to 15 mm.

Meanwhile, each of the very small openings 207 of the porous plate 202 has an opening size of about 5 mm (or 2 to 6 mm), a distance between the very small openings 207 adjacent to each other is about 7 mm (or 5 to 10 mm), and the thickness of the porous plate 202 is about 3 mm (or 1 to 5 mm).

The flowing direction of warm air, i.e., the air 4 blown out from the blowing opening 21 in the vehicle compartment 94 tends to be influenced by a direction in which the air 4 flows in the duct blowing portion 20.

In the heat supply element 10 of embodiment 5, the direction in which the air 4 flows in the duct blowing portion 20 is the same as the axial direction of the duct blowing portion 20, that is, the axial direction of the base body 200. Meanwhile, the depth direction of the slit-like blowing opening 21 is orthogonal to the axial direction of the duct blowing portion 20 and the axial direction of the base body 200. Furthermore, the longitudinal direction of the slit-like blowing opening 21 is the same as the axial direction of the duct blowing portion 20, that is, the same as the direction in which the air 4 flows in the duct blowing portion 20. Therefore, the direction in which the air 4 blown out from the blowing opening 21 flows in the vehicle compartment 94 is unlikely to become the depth direction of the blowing opening 21, i.e., the direction orthogonal to the axial direction of the duct blowing portion 20, and tends to deviate toward the front side in the direction in which the air 4 flows in the duct blowing portion 20, that is, toward the vehicle rear side in embodiment 5.

Therefore, for example, as shown in FIG. 3, even in a case where the blowing opening 21 is disposed so as to oppose the thigh portion 91 of the occupant 90 in order to blow warm air toward the thigh portion 91 of the occupant 90, the warm air blown out from the blowing opening 21 actually flows toward the vehicle rear side, and a target heating effect is not obtained in some cases.

As shown in FIG. 7 and FIG. 8, in the heat supply element 10 of embodiment 5, the duct blowing portion 20 includes the guide fin member 201 and the porous plate 202, whereby the blowing opening 21 is defined so as to reduce stepwise the opening size in the depth direction of the blowing opening 21, that is, in the direction orthogonal to the axial direction of the duct blowing portion 20. Thus, warm air blown out from the blowing opening 21 is positively or forcibly guided in the direction orthogonal to the axial direction of the duct blowing portion 20. That is, in the heat supply element 10 of embodiment 5, the directivity of warm air blown out from the blowing opening 21 is enhanced in the vehicle compartment 94, and the warm air is supplied to a target position such as, for example, the thigh portion 91 of the occupant 90.

Therefore, in the heat supply element 10 of embodiment 5, the vehicle compartment 94 is efficiently heated at such a temperature that the occupant 90 feels comfortable.

The inventor of the present invention actually performed an evaluation test and proved that the flow rate at each of positions A, B, and C in FIG. 8 was in a range of 1 to 2 m/minute and warm air was blown out from the blowing opening 21 at a rate that is almost uniform in the longitudinal direction of the slit-like blowing opening 21.

The opening size of the small opening 206 of the guide fin member 201 is preferably in a range of 8 to 40 mm, a distance (that is, the width of the fin part 204) between the small openings 206 adjacent to each other is preferably in a range of 2 to 15 mm, the opening size of the very small opening 207 of the porous plate 202 is preferably in a range of 2 to 6 mm, a distance between the very small openings 207 adjacent to each other is preferably in a range of 5 to 10 mm, and the depth of the very small opening 207, i.e., the thickness of the porous plate 202, is preferably in a range of 1 to 5 mm, in order to obtain the above-described effect with high reliability.

### Embodiment 6

In embodiment 6, portions other than the heat supply element 10 in the heating system for a vehicle compartment according to the present invention will be mainly described.

A heat recovery element and other elements typified by a PTC heater, a temperature sensor, and the like according to each of embodiment 6 and other embodiments described below, are allowed to be used in combination with the heat supply element of each of the above-described embodiments as appropriate, or with another heat supply element illustrated below as appropriate.

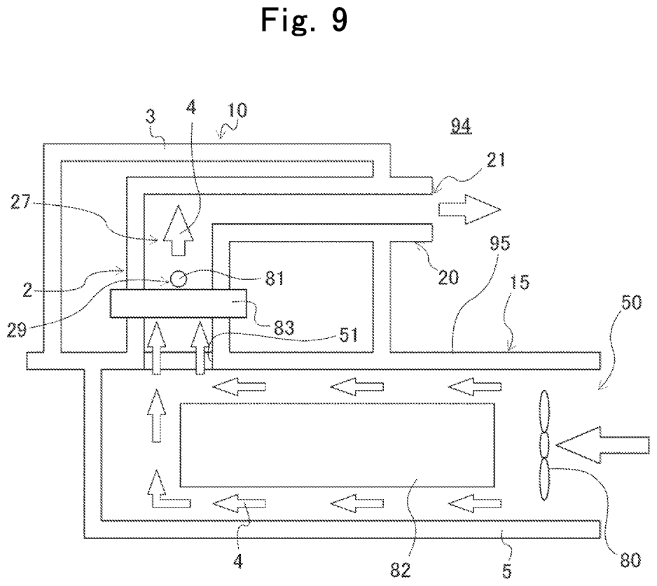

FIG. 9 schematically illustrates a heating system for a vehicle compartment according to embodiment 6.

The heating system for a vehicle compartment according to embodiment 6 includes the heat recovery element 15, the heat supply element 10, and a temperature sensor 81. The heat supply element 10 is almost the same as the heat supply element 10 described in embodiment 4.

The heat recovery element 15 is structured by a heat source storage chamber 5. The heat source storage chamber 5 is box-shaped and is disposed below a vehicle compartment floor 95. A space is defined inside the heat source storage chamber 5. An automotive battery 82 is stored in the space.

The heat source storage chamber 5 has an inlet opening 50 and an outlet opening 51. The inlet opening 50 connects to the vehicle compartment 94 through a not-illustrated air duct. A transport unit 80 of the heat supply element 10 is disposed in the inlet opening 50 side portion in the heat source storage chamber 5. In embodiment 6, the transport unit 80 is a blower.

The outlet opening 51 of the heat source storage chamber 5 connects to the duct portion 2. The duct portion 2 includes the duct general portion 27 and the duct blowing portion 20 as described above. The duct portion 2 is integrated with the console box 3. In the heating system for a vehicle compartment according to embodiment 6, a heater storage portion 29 for storing a PTC heater 83 is disposed in the lower portion of the console box 3. Specifically, the heater storage portion 29 is formed as a part of the duct general portion 27. The duct blowing portion 20 is connected to the duct general portion 27 on the downstream side with respect to the heater storage portion 29. In the description herein, the downstream side represents the downstream side in the direction in which the heat exchange medium, i.e., the air 4 flows. Similarly to embodiment 4, the duct blowing portion 20 extends in the rear portion of the console box 3, and the blowing opening 21 of the duct blowing portion 20 faces toward a not-illustrated rear seat.

The heater storage portion 29 stores both the temperature sensor 81 and the PTC heater 83. Power is supplied to the temperature sensor 81, the PTC heater 83, and the above-described transport unit 80 from the automotive battery 82. The temperature sensor 81, the PTC heater 83, and the transport unit 80 are connected to a not-illustrated control unit, and are controlled to be driven by the control unit. As the control unit, for example, an ECU (electronic control unit) is used or a control unit independent of other control units is used.

Heat is generated from the automotive battery 82 by operating the electric vehicle. The automotive battery 82 stored in the heat source storage chamber 5 exchanges heat with the heat exchange medium, i.e., the air 4 which is also in the heat source storage chamber 5. The air 4 in the heat source storage chamber 5 is caused to flow by the transport unit 80 and flows into the duct general portion 27 through the outlet opening 51 to reach the heater storage portion 29. Therefore, the air 4 heated by heat exchange with the automotive battery 82 is further heated by the PTC heater 83 in the heater storage portion 29. The air 4 that has been further heated by PTC heater 83 flows through the duct general portion 27 into the duct blowing portion 20 and is supplied through the blowing opening 21 to the vehicle compartment 94.

In the heating system for a vehicle compartment according to embodiment 6, the air 4, i.e., the heat exchange medium which is to flow in the duct portion 2 as the connection chamber exchanges heat with the PTC heater 83 as an electric heater, and is thereafter supplied to the vehicle compartment 94 and exchanges heat with air in the vehicle compartment 94. That is, the air 4 is preheated by the automotive battery 82 and supplied to the PTC heater 83. Therefore, the heating system for a vehicle compartment according to embodiment 6 has an advantage that the air 4 which has been sufficiently heated by the PTC heater 83 is supplied to the vehicle compartment 94 and, furthermore, power required for the PTC heater 83 is reduced.

The temperature sensor 81, the PTC heater 83, and the transport unit 80 are controlled to be driven by a not-illustrated control unit, and, for example, operation/stop and output of the PTC heater 83, the transport unit 80, or the like are controlled according to a temperature detected in the duct portion 2 by the temperature sensor 81. For example, the operation/stop and output of the PTC heater 83, the transport unit 80, or the like are controlled also according to a driven state of the electric vehicle. For example, immediately after operation of the electric vehicle is started, when an amount of heat generated by the automotive battery 82 is small, the transport unit 80 or the PTC heater 83 is stopped.

In a case where an amount of heat generated by the automotive battery 82 is small, appropriate increase of a temperature of the heat exchange medium such as the air 4 is difficult. Therefore, the vehicle compartment 94 is not sufficiently heated only by heat recovered from the automotive battery 82, and a high power is required for the PTC heater 83 in some cases. In a case where the heat exchange medium has a low temperature, the temperature of the heat exchange medium is not sufficiently increased even by heating the PTC heater 83, and cool air is supplied to the vehicle compartment 94 and the occupant 90 feels uncomfortable in some cases. The transport unit 80 or the PTC heater 83 is stopped when an amount of heat generated by the automotive battery 82 is small, whereby supply of cool air to the vehicle compartment 94 or consumption of high power by the PTC heater 83 is reduced.

The transport unit 80 and the PTC heater 83 are each independently controlled to be driven or are controlled to be driven in synchronization with each other.

Furthermore, the outlet opening 51 or the inlet opening 50 is allowed to have a not-illustrated valve, and, in this case, opening and closing of the valve is controlled by the control unit. For example, in a case where an amount of heat generated by the automotive battery 82 is small, the valves in the inlet opening 50 and/or the outlet opening 51 are closed to almost hermetically seal the heat source storage chamber 5, whereby the automotive battery 82 is heated early and heat generated by the automotive battery 82 is utilized early for heating.

### Embodiment 7

A heating system for a vehicle compartment according to embodiment 7 is almost the same as the heating system for a vehicle compartment according to embodiment 6 except that the heating system for a vehicle compartment according to embodiment 7 includes a liquid heat exchange medium, and has a path for transporting the liquid heat exchange medium.

Therefore, in embodiment 7, differences from the heating system for a vehicle compartment according to embodiment 6 will be mainly described below.

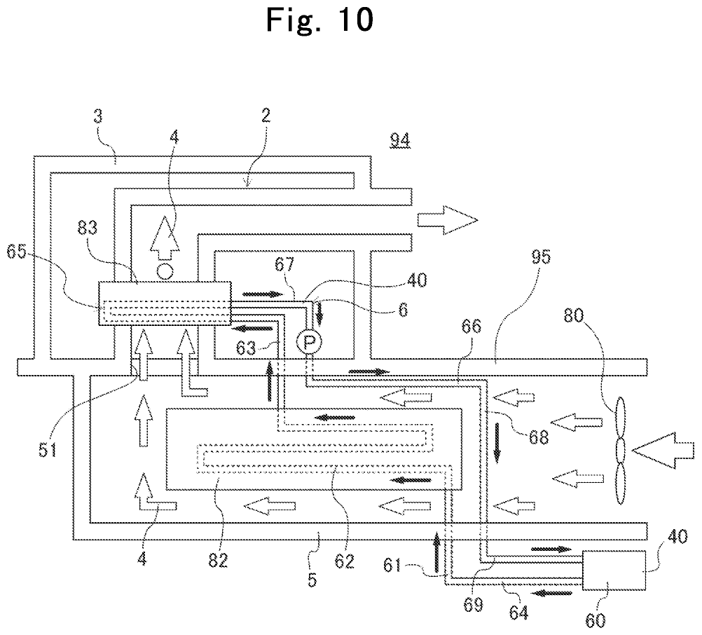

FIG. 10 schematically illustrates the heating system for a vehicle compartment according to embodiment 7.

The heating system for a vehicle compartment according to embodiment 7 includes a long life coolant (LLC) 40 as the liquid heat exchange medium and a path for transporting the LLC 40. The LLC 40 circulates between the heat source storage chamber 5 and the vehicle compartment 94 through another transport path different from that for the air 4. Hereinafter, the path for transporting the LLC 40 is referred to as a liquid transport path 6. In the heating system for a vehicle compartment according to embodiment 7, a part of the liquid transport path 6, specifically, a first heater core connection portion 63 described below, forms a part of the connection chamber.

The liquid transport path 6 includes a liquid tank 60, a first path portion 61, a heater core 65, a second path portion 66, and a liquid transport pump P.

Among them, the liquid tank 60 is disposed outside the heat source storage chamber 5, and stores the LLC 40 thereinside. The heater core 65 is in contact with the PTC heater 83 on a side upstream of the PTC heater 83, that is, on the side of the outlet opening 51 of the heat source storage chamber 5. The first path portion 61 has a tubular shape, and connects between the liquid tank 60 and the heater core 65. The second path portion 66 also has a tubular shape and connects between the liquid tank 60 and the heater core 65.

More specifically, a heat exchange path portion 62 that is a part of the first path portion 61 is disposed near the automotive battery 82 in the heat source storage chamber 5. The first heater core connection portion 63 which is another part of the first path portion 61 connects to the heat exchange path portion 62 and connects to the heater core 65 outside the heat source storage chamber 5. A first liquid tank connection portion 64 which is another part of the first path portion 61 connects to the liquid tank 60 outside the heat source storage chamber 5.

A second heater core connection portion 67 which is a part of the second path portion 66 connects to the heater core 65 outside the heat source storage chamber 5. A return portion 68 which is another part of the second path portion 66 connects to the second heater core connection portion 67 inside the heat source storage chamber 5. The return portion 68 is spaced from the automotive battery 82 in the heat source storage chamber 5. The liquid transport pump P is connected to the second heater core connection portion 67. A second liquid tank connection portion 69 which is another part of the second path portion 66 connects to the liquid tank 60 outside the heat source storage chamber 5.

The LLC 40 circulates in the liquid tank 60, the first path portion 61, the heater core 65, the second path portion 66, and the liquid transport pump P, and the direction in which the LLC 40 circulates is determined by the liquid transport pump P as one direction from the liquid tank 60→the first liquid tank connection portion 64→the heat exchange path portion 62→the first heater core connection portion 63→the heater core 65→the second heater core connection portion 67→the liquid transport pump P→the second heater core connection portion 67→the return portion 68→the second liquid tank connection portion 69→the liquid tank 60 . . . .

Among the above-described components, the heat exchange path portion 62 corresponds to the heat recovery element 15 similarly to the heat source storage chamber 5. Meanwhile, the first heater core connection portion 63 and the heater core 65 correspond to the heat supply element 10.

The liquid transport pump P receives power supplied from the automotive battery 82 similarly to the transport unit 80, and is controlled to be driven by a not-illustrated control unit. By driving the liquid transport pump P, when the LLC 40 flowing from the liquid tank 60 toward the heater core 65 passes through the heat exchange path portion 62 in the heat source storage chamber 5, the LLC 40 exchanges heat with automotive battery 82 and is heated. The LLC 40 heated when passing through the heat exchange path portion 62 is further supplied through the first heater core connection portion 63 to the heater core 65 that is in contact with the PTC heater 83. The heater core 65 has a radiator-like structure. Therefore, the heated LLC 40 exchanges heat with the PTC heater 83 in the heater core 65. That is, the PTC heater 83 is heated by the heated LLC 40 at this time. The PTC heater 83 heats the air 4 as another heat exchange medium as in embodiment 6. Therefore, also in the heating system for a vehicle compartment according to embodiment 7, warm air is supplied to the vehicle compartment 94.

The heating system for a vehicle compartment according to embodiment 7 has an advantage that, for example, immediately after operation of the PTC heater 83 is started, when the PTC heater 83 has a relatively low temperature, power required for increasing the temperature of the PTC heater 83 to a required temperature is reduced.

### Embodiment 8

A heating system for a vehicle compartment according to embodiment 8 has no console box, and has an in-chamber transmission portion disposed below a vehicle compartment floor, as the connection chamber, instead of a duct portion integrated with the console box.

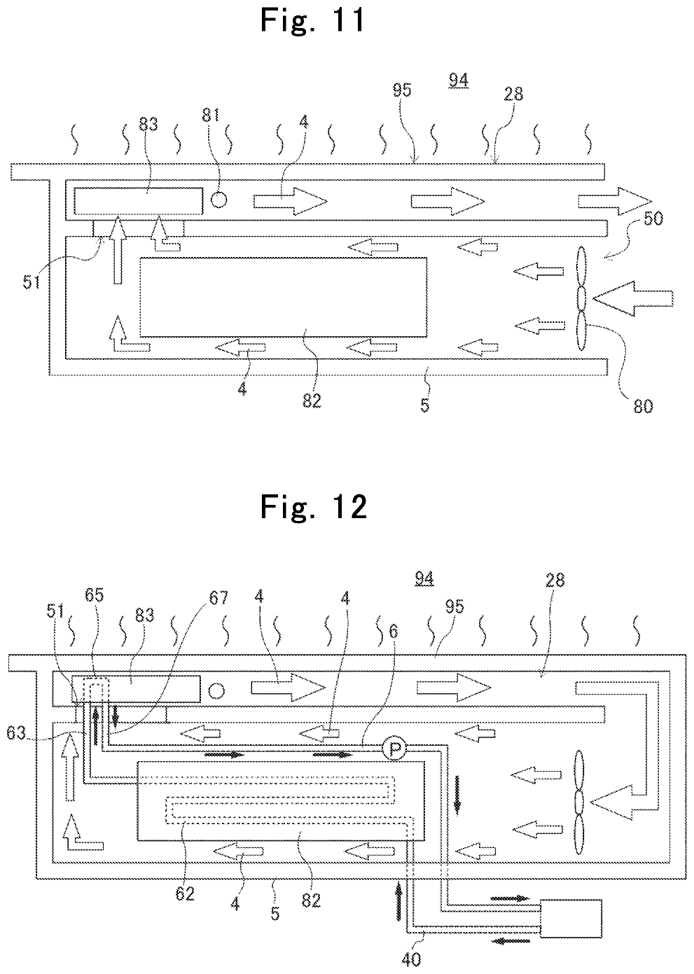

FIG. 11 schematically illustrates the heating system for a vehicle compartment according to embodiment 8.

In the heating system for a vehicle compartment according to embodiment 8, the heat source storage chamber 5, the transport unit 80, the PTC heater 83, and the temperature sensor 81 are almost the same as those in the heating system for a vehicle compartment according to embodiment 6.

In the heating system for a vehicle compartment according to embodiment 8, a duct-like in-chamber transmission portion 28 is disposed between the heat source storage chamber 5 and the vehicle compartment floor 95. The in-chamber transmission portion 28 connects to the outlet opening 51 of the heat source storage chamber 5 and the outside, and the inlet opening 50 of the heat source storage chamber 5 also connects to the outside. The PTC heater 83 is disposed in the in-chamber transmission portion 28.

In the heating system for a vehicle compartment according to embodiment 8, the air 4 heated by heat exchange with the automotive battery 82 is supplied from the outlet opening 51 of the heat source storage chamber 5 to the in-chamber transmission portion 28, and is further heated by heat exchange with the PTC heater 83. The air 4 passing through the PTC heater 83 is discharged to the outside through the in-chamber transmission portion 28. When the air 4 passes through the in-chamber transmission portion 28, the air 4 exchanges heat with the vehicle compartment floor 95. The vehicle compartment floor 95 exchanges heat with air in the vehicle compartment 94, thereby heating the vehicle compartment 94. That is, the heating system for a vehicle compartment according to embodiment 8 is a floor heating system.

### Embodiment 9

A heating system for a vehicle compartment according to embodiment 9 is almost the same as the heating system for a vehicle compartment according to embodiment 8 except that the heating system for a vehicle compartment according to embodiment 9 includes a liquid heat exchange medium and has a path for transporting the liquid heat exchange medium, and the in-chamber transmission portion connects to an outlet opening and an inlet opening of the heat source storage chamber.

FIG. 12 schematically illustrates the heating system for a vehicle compartment according to embodiment 9.

In the heating system for a vehicle compartment according to embodiment 9, the liquid transport path 6 is almost the same as the liquid transport path 6 in the heating system for a vehicle compartment according to embodiment 7 except that each of the first heater core connection portion 63 and the second heater core connection portion 67 is disposed inside the heat source storage chamber 5 and connects through the outlet opening 51 to the heater core 65.

In the heating system for a vehicle compartment according to embodiment 9, the air 4 heated by heat exchange with the automotive battery 82 is heated by heat exchange with the PTC heater 83 in the in-chamber transmission portion 28, and exchanges heat with the vehicle compartment floor 95 as in embodiment 8. The vehicle compartment floor 95 exchanges heat with air in the vehicle compartment 94, thereby heating the vehicle compartment 94.

Furthermore, in the present embodiment, the air 4 flowing out from the in-chamber transmission portion 28 is supplied to the heat source storage chamber 5. Therefore, the present embodiment has an advantage that the air 4 circulates between the in-chamber transmission portion 28 and the heat source storage chamber 5, and heat loss of the air 4 is reduced.

Meanwhile, the LLC 40 is heated by heat exchange with the automotive battery 82 when passing through the heat exchange path portion 62 in the heat source storage chamber 5, and further exchanges heat with the PTC heater 83 in the heater core 65, thereby preheating the PTC heater 83. Accordingly, also in the heating system for a vehicle compartment according to embodiment 9, power required for increasing the temperature of the PTC heater 83 to a required temperature is reduced. The heating system for a vehicle compartment according to embodiment 9 is for heating the floor. Thus, the temperature of the PTC heater 83 required for the heating is relatively low. Therefore, a difference between the temperature of the PTC heater 83 required for the heating and a temperature to which the PTC heater 83 is preheated by heat transfer from the heat exchange medium, i.e., the air 4 and the LLC 40, is small. Therefore, in the heating system for a vehicle compartment according to embodiment 9, an effect of reducing power is significantly exerted by preheating the PTC heater 83.

### Embodiment 10

In a heating system for a vehicle compartment according to embodiment 10, a heater duct for storing the PTC heater is disposed below the vehicle compartment floor. A duct portion is further disposed as the connection chamber below the heater duct.

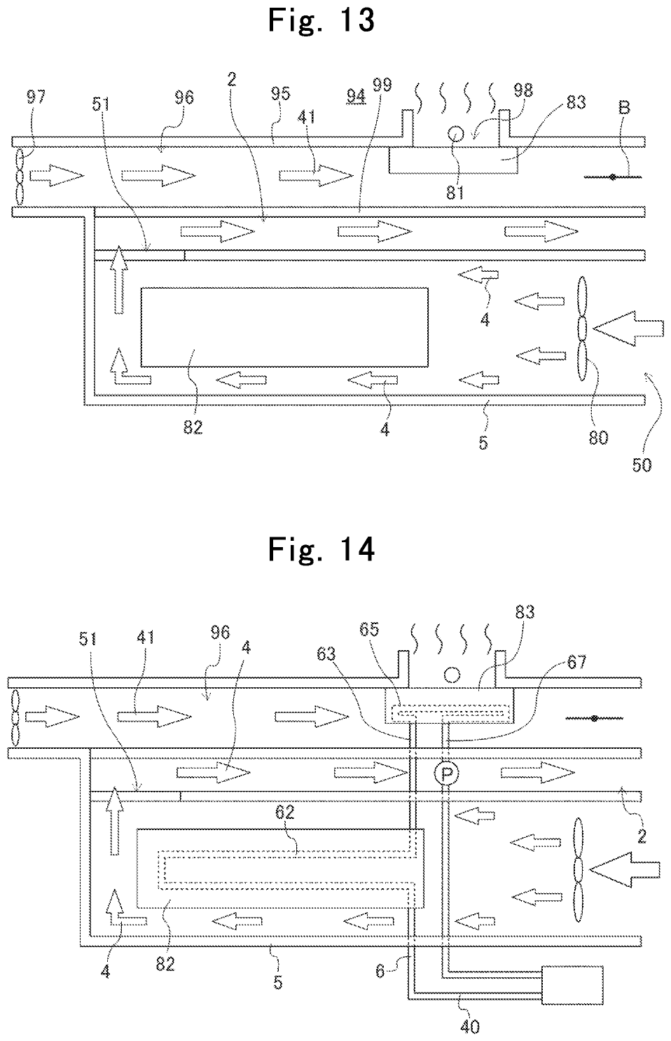

FIG. 13 schematically illustrates the heating system for a vehicle compartment according to embodiment 10.

In the heating system for a vehicle compartment according to embodiment 10, the heat source storage chamber 5, the transport unit 80, the PTC heater 83, and the temperature sensor 81 are almost the same as those in the heating system for a vehicle compartment according to embodiment 6.

In the heating system for a vehicle compartment according to embodiment 10, the duct portion 2 that connects to the outlet opening 51 of the heat source storage chamber 5 is disposed above the heat source storage chamber 5, and a heater duct 96 is further disposed above the duct portion 2. A blower is disposed as a second transport unit 97 in the heater duct 96, and air 41 as a third heat exchange medium flows in the heater duct 96 through a path other than the heat source storage chamber 5 and the connection chamber. A flow path opening and closing valve B is disposed in the heater duct 96. By stopping the second transport unit 97 and closing the flow path opening and closing valve B, the heater duct 96 is hermetically sealed and flow of the air 41 in the heater duct 96 is stopped.

Air flowing out of the duct portion 2 flows into the inlet opening 50 of the heat source storage chamber 5 through a not-illustrated air duct.

In the heating system for a vehicle compartment according to embodiment 10, the air 4 heated by heat exchange with the automotive battery 82 in the heat source storage chamber 5 is supplied to the duct portion 2 from the outlet opening 51 of the heat source storage chamber 5, and exchanges heat with the air 41 in the heater duct 96 adjacent to the duct portion 2. The air 41 in the heater duct 96 exchanges heat with the PTC heater 83, thereby preheating the PTC heater 83. Therefore, also in the heating system for a vehicle compartment according to embodiment 10, power required for increasing the temperature of the PTC heater 83 to a required temperature is reduced.

The vehicle compartment floor 95 has a floor opening 98, and the PTC heater 83 is exposed at the floor opening 98. Therefore, in embodiment 10, the PTC heater 83 directly heats air in the vehicle compartment 94. The PTC heater 83 is preheated by heat exchange with the automotive battery 82 through the air 4 as the heat exchange medium and the air 41 as the third heat exchange medium. Therefore, also in embodiment 10, the automotive battery 82 and air in the vehicle compartment 94 are considered to exchange heat with each other through the heat exchange medium.

A boundary wall portion 99 as a boundary between the duct portion 2 and the heater duct 96 is formed of, for example, a heat transfer material. In this case, the air 4 in the duct portion 2 and the air 41 in the heater duct 96 efficiently exchange heat with each other through the boundary wall portion 99 having an excellent heat transfer property.

In a case where a gap is formed between the floor opening 98 and the PTC heater 83, the air 41 flowing in the heater duct 96 is allowed to be blown out into the vehicle compartment 94 from the floor opening 98 of the vehicle compartment floor 95 through the gap. In this case, air in the vehicle compartment 94 exchanges heat with not only the PTC heater 83 but also the air 41 blown out into the vehicle compartment 94.

In the heating system for a vehicle compartment according to embodiment 8 or embodiment 9, the vehicle compartment floor 95 is allowed to have the floor opening 98. In this case, the air 4 flowing in the in-chamber transmission portion 28 is blown out into the vehicle compartment 94 through the floor opening 98, and exchanges heat with air in the vehicle compartment 94.

### Embodiment 11

A heating system for a vehicle compartment according to embodiment 11 is almost the same as the heating system for a vehicle compartment according to embodiment 10 except that the heating system for a vehicle compartment according to embodiment includes a liquid heat exchange medium, and has a path for transporting the liquid heat exchange medium.

FIG. 14 schematically illustrates the heating system for a vehicle compartment according to embodiment 11.

In the heating system for a vehicle compartment according to embodiment 11, the liquid transport path 6 is almost the same as the liquid transport path 6 of the heating system for a vehicle compartment according to embodiment 7 except that each of the first heater core connection portion 63 and the second heater core connection portion 67 is disposed inside the duct portion 2 and the heater duct 96 outside the heat source storage chamber 5 in embodiment 11.

In the heating system for a vehicle compartment according to embodiment 11, the air 4 heated by heat exchange with the automotive battery 82 in the heat source storage chamber 5 is supplied to the duct portion 2 from the outlet opening 51 of the heat source storage chamber 5, and exchanges heat with the air 41 in the heater duct 96 adjacent to the duct portion 2. The air 41 in the heater duct 96 exchanges heat with the PTC heater 83, thereby preheating the PTC heater 83.

Meanwhile, the LLC 40 is heated by heat exchange with the automotive battery 82 when passing through the heat exchange path portion 62 in the heat source storage chamber 5, and further exchanges heat with the PTC heater 83 in the heater core 65, thereby preheating the PTC heater 83.

Therefore, also in the heating system for a vehicle compartment according to embodiment 11, power required for increasing the temperature of the PTC heater 83 to a required temperature is reduced.

### Embodiment 12

In embodiment 12, a porous tubular formed product that forms the heat source storage chamber, the connection chamber such as the duct portion and the in-chamber transmission portion, the heater duct, and the like in the heating system for a vehicle compartment according to the present invention will be mainly described.

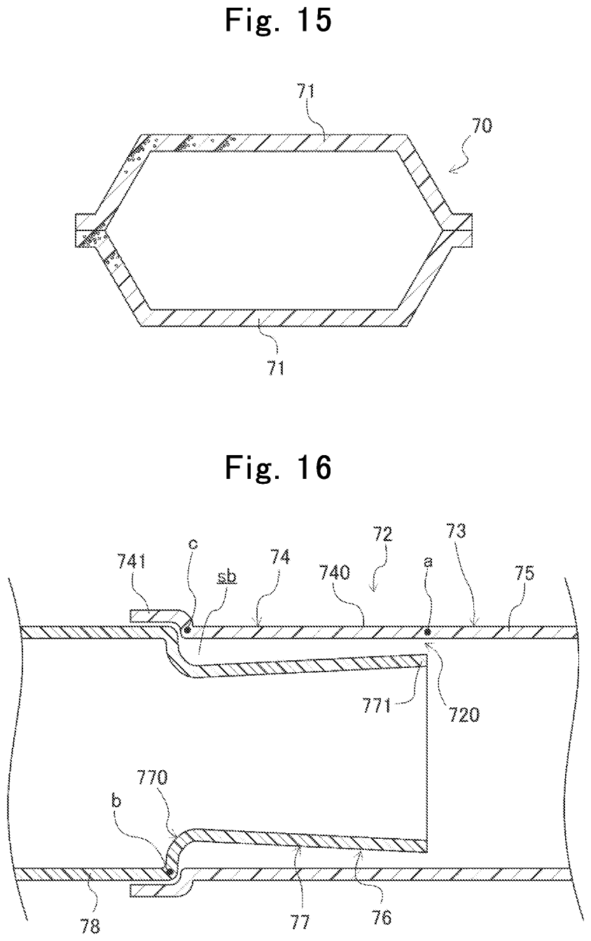

FIG. 15 schematically illustrates the porous tubular formed product according to embodiment 12. The porous tubular formed product is combined with each of the components described in embodiment 1 to embodiment 11 or each component itself is formed of the porous tubular formed product.

As shown in FIG. 15, a porous tubular formed product 70 according to embodiment 12 is formed of resin and is formed by a plurality of partial portions 71 being integrated with each other.

Each partial portion 71 is obtained by shaping a plate-like porous body by a vacuum forming method, a compression forming method, or the like. The partial portions 71 are integrated by a known method such as hot plate welding, vibration welding, or adhesion. Furthermore, the plate-like porous body itself is produced as appropriate by a known forming method such as foam molding. More specifically, the plate-like porous body used for producing the porous tubular formed product 70 according to embodiment 12 is a foamed polyethylene sheet having an expansion ratio of 20 times and a thickness of 2 to 4 mm.

The components which are the heat source storage chamber 5, the connection chamber such as the duct portion 2 and the in-chamber transmission portion 28, the heater duct 96, and the like as described above are formed of the porous tubular formed product 70, whereby these components have various performances such as heat insulating performance, sound absorbing performance, silencing performance, and sound insulating performance. Each of the above-described components tends to generate noise since a heat exchange medium such as air flows therethrough. However, in a case where these components are each formed of the porous tubular formed product 70, sound absorbing performance, silencing performance, or sound insulating performance of the porous tubular formed product 70 allow the noise to be reduced.

Furthermore, particularly in a case where the automotive battery 82 is stored in the heat source storage chamber 5, the inside and the outside of the heat source storage chamber 5 are thermally insulated from each other by the heat insulating performance of the porous tubular formed product 70. In this case, since loss of heat generated by the automotive battery 82 is reduced, there is also an advantage that the heat is efficiently recovered by the air 4 and the LLC 40 as the heat exchange medium, and supplied to the vehicle compartment 94.

The heat source storage chamber 5 is formed of the porous tubular formed product 70, whereby there is also an advantage that reduction of the temperature of the automotive battery 82 is inhibited particularly when the vehicle is stopped and parked in a cold state, and operation of the electric vehicle is started without trouble.

### Embodiment 13

In embodiment 13, a two-component combination type tubular member that forms the connection chamber such as the duct portion and the in-chamber transmission portion, the heater duct, and the like in the heating system for a vehicle compartment according to the present invention will be mainly described.

FIG. 16 schematically illustrates the tubular member of embodiment 13. The tubular member is combined with each of the components described in embodiment 1 to embodiment 12 or each component itself is formed of the tubular member.

As shown in FIG. 16, a tubular member 72 of embodiment 13 is formed of resin, and formed by two tubular partial portions being integrated with each other. One of the partial portions is referred to as a first partial portion 73, one end portion of the first partial portion 73 in the axial direction is referred to as an outer tubular portion 74, and a portion of the first partial portion 73 other than the outer tubular portion 74 is referred to as a first general portion 75. A position a shown in FIG. 16 represents a boundary between the outer tubular portion 74 and the first general portion 75.

The other of the partial portions is referred to as a second partial portion 76, one end portion of the second partial portion 76 in the axial direction is referred to as an inner tubular portion 77, and a portion of the second partial portion 76 other than the inner tubular portion 77 is referred to as a second general portion 78. A position b shown in FIG. 16 represents a boundary between the inner tubular portion 77 and the second general portion 78.

The first partial portion 73 and the second partial portion 76 are integrated by inserting the inner tubular portion 77 in the outer tubular portion 74. That is, the outer tubular portion 74 is disposed on the outer side of the inner tubular portion 77. The thickness of the first partial portion 73 and the thickness of the second partial portion 76 are each almost constant.

The outer tubular portion 74 of the first partial portion 73 has an outer general portion 740 continuous with the first general portion 75 and an outer mounting portion 741 continuous with the outer general portion 740. A position c shown in FIG. 16 represents a boundary between the outer general portion 740 and the outer mounting portion 741.

The outer mounting portion 741 is considered to be one end portion of the first partial portion 73 in the axial direction and also to be a portion of the outer tubular portion 74 disposed on the side opposite to the first general portion 75 side.

The inner diameter of the first general portion 75 and the inner diameter of the outer general portion 740 are equal to each other, and the inner diameter of the outer mounting portion 741 is slightly greater than the inner diameter of the first general portion 75 and the inner diameter of the outer general portion 740.

The inner diameter and the outer diameter of the second general portion 78 are each almost constant in the axial direction of the second general portion 78. Each of the inner diameter and the outer diameter of the inner tubular portion 77 varies for each portion in the axial direction of the inner tubular portion 77. The inner diameter of the inner tubular portion 77 is smallest at a boundary portion 770 between the inner tubular portion 77 and the second general portion 78, and gradually increases toward the end portion on the side opposite to the second general portion 78 side. The inner diameter of the inner tubular portion 77 at the boundary portion 770 is less than the inner diameter of the second general portion 78 continuous with the boundary portion 770, and the inner diameter of the inner tubular portion 77 is considered to be abruptly reduced at the boundary portion 770 between the inner tubular portion 77 and the second general portion 78.

In other words, the flow path cross-sectional area of the inner tubular portion 77 is considered to be abruptly reduced at the boundary portion 770 between the inner tubular portion 77 and the second general portion 78, and to be gradually increased toward the end portion on the side opposite to the second general portion 78 side.

As shown in FIG. 16, in a state where the first partial portion 73 and the second partial portion 76 are combined with each other, the outer general portion 740 covers the inner tubular portion 77 and the outer mounting portion 741 covers a portion of the second general portion 78 on the inner tubular portion 77 side. Inside the tubular member 72 in which the first partial portion 73 and the second partial portion 76 are combined with each other, a space sb is defined by the inner circumferential surface of the outer general portion 740 and the outer circumferential surface of the inner tubular portion 77. The space sb functions as a side-branch silencer. A distance between the inner circumferential surface of the outer general portion 740 and the outer circumferential surface of the inner tubular portion 77 is greatest near the boundary portion 770, and is gradually reduced toward the end portion, i.e., an inner end portion 771 on the side opposite to the second general portion 78 side of the inner tubular portion 77. The outer circumferential surface of the inner end portion 771 is distant from the inner circumferential surface of the outer general portion 740, and an inlet 720 of the space sb, i.e., an inlet 720 of the side-branch silencer is defined by the portions distant from each other.

As shown in FIG. 16, on the cross-section of the inner tubular portion 77 in the axial direction, the curvature of the inner tubular portion 77 is greatest at the boundary portion 770, and is gradually reduced toward the inner end portion 771. Therefore, the inner tubular portion 77 has a so-called bell mouth shape.

In a case where the inner tubular portion 77 has the bell mouth shape, fluid passing through the second partial portion 76 is rectified by the inner tubular portion 77. Therefore, although the tubular member 72 has a double tubular structure serving as a side-branch silencer therein, pressure loss inside the tubular member 72 is not so great.

The tubular member 72 of embodiment 13 allows noise inside the tubular member 72 to be reduced while inhibiting increase of pressure loss. Therefore, the tubular member 72 of embodiment 13 is suitable for forming a portion which acts as a flow path of a heat exchange medium such as air and generates noise, in the heating system for a vehicle compartment according to the present invention, for example, for forming the components which are the connection chamber such as the duct portion 2 and the in-chamber transmission portion 28, the heater duct 96, and the like, similarly to the above-described porous tubular formed product 70 according to embodiment 12. As in embodiment 12, the plate-like porous body is shaped, and a plurality of the shaped porous bodies are integrated with each other by hot plate welding, vibration welding, or the like, whereby the first partial portion 73 and/or the second partial portion 76 that have functions as the porous tubular formed product 70 are allowed to be formed. In this case, the tubular member 72 of embodiment 13 has various performances such as heat insulating performance, sound absorbing performance, silencing performance, and sound insulating performance in addition to the function as the above-described side-branch silencer.

A distance between the outer circumferential surface of the inner end portion 771 in the inner tubular portion 77, and the inner circumferential surface of the outer tubular portion 74 is 5 mm in the tubular member 72 of embodiment 13. The length of the inner tubular portion 77 in the axial direction and the length of the outer general portion 740 in the axial direction are each 85 mm. In other words, in the tubular member 72 of embodiment 13, the width of the inlet 720 of the side-branch silencer is 5 mm, and the length of the side-branch silencer in the axial direction is 85 mm.

The width of the inlet 720 of the side-branch silencer is preferably in a range of 2 to 7 mm and more preferably in a range of 3 to 6 mm in order to advantageously exhibit the effect of the side-branch silencer. The length of the side-branch silencer in the axial direction is preferably in a range of 70 to 100 mm and more preferably in a range of 75 to 95 mm.

The present invention is not limited to the embodiments described above and in the drawings, and can be implemented after being appropriately modified without departing from the gist of the invention. Furthermore, components shown in the description including the embodiments may be extracted and freely combined to be implemented.

The heating system for a vehicle compartment according to the present invention is represented as follows.

[1]

A heating system for a vehicle compartment includes: a heat source storage chamber 5 disposed below a vehicle compartment floor 95 of an electric vehicle and configured to store at least one heat source element unit selected from an automotive battery 82, a motor, a converter, and an inverter; and a connection chamber configured to connect between the heat source storage chamber 5 and the vehicle compartment 94. A heat exchange medium 4 flows in the heat source storage chamber 5 and the connection chamber. The heat source element unit and air in the vehicle compartment 94 exchange heat with each other through the heat exchange medium 4.

[2]

In the heating system for a vehicle compartment according to [1], the connection chamber includes a duct blowing portion 20 that is disposed in the vehicle compartment 94 and is opened at the vehicle compartment 94, and the heat exchange medium 4 is air 4, and is introduced into the vehicle compartment 94 through an opening of the duct blowing portion 20.

[3]

The heating system for a vehicle compartment according to [2] further includes a console box 3 disposed in the vehicle compartment 94, and the duct blowing portion 20 is integrated with the console box 3.

[4]

The heating system for a vehicle compartment according to [2] further includes a door trim 30 exposed to the vehicle compartment 94, and the duct blowing portion 20 is integrated with the door trim 30.

[5]

In the heating system for a vehicle compartment according to [1], the connection chamber has an in-chamber transmission portion 28 disposed below the vehicle compartment floor 95, and the heat exchange medium 4 flows in the in-chamber transmission portion 28, and exchanges heat with air in the vehicle compartment 94 through the vehicle compartment floor 95.

[6]

In the heating system for a vehicle compartment according to [1], the connection chamber connects to an electric heater disposed in the electric vehicle, and the heat exchange medium 4 flowing in the connection chamber further exchanges heat with the electric heater.

[7]

In the heating system for a vehicle compartment according to [6], the heat exchange medium 4 flowing in the connection chamber exchanges heat with the electric heater, and thereafter exchanges heat with air in the vehicle compartment 94.

[8]

In the heating system for a vehicle compartment according to [6], the electric heater exchanges heat with the heat exchange medium 4 flowing in the connection chamber and thereafter exchanges heat with air in the vehicle compartment 94.

### DESCRIPTION OF REFERENCE CHARACTERS

2: connection chamber (duct portion)
4: heat exchange medium (air)
5: heat source storage chamber
28: connection chamber (in-chamber transmission portion)
40: heat exchange medium (LLC)
41: heat exchange medium (air)
63: connection chamber (first heater core connection portion)
82: heat source element unit (automotive battery)
94: vehicle compartment
95: vehicle compartment floor

1. A heating system for a vehicle compartment, the heating system comprising:
a heat source storage chamber disposed below a vehicle compartment floor of an electric vehicle and configured to store at least one heat source element unit selected from an automotive battery, a motor, a converter, and an inverter; and
a connection chamber configured to connect between the heat source storage chamber and the vehicle compartment, wherein
a heat exchange medium flows in the heat source storage chamber and the connection chamber, and
the heat source element unit and air in the vehicle compartment exchange heat with each other through the heat exchange medium.

2. The heating system for a vehicle compartment according to claim 1, wherein
the connection chamber includes a duct blowing portion that is disposed in the vehicle compartment and is opened at the vehicle compartment, and
the heat exchange medium is air, and is introduced into the vehicle compartment through an opening of the duct blowing portion.

3. The heating system for a vehicle compartment according to claim 2, further comprising a console box disposed in the vehicle compartment, wherein
the duct blowing portion is integrated with the console box.

4. The heating system for a vehicle compartment according to claim 2, further comprising a door trim exposed to the vehicle compartment, wherein
the duct blowing portion is integrated with the door trim.

5. The heating system for a vehicle compartment according to claim 1, wherein
the connection chamber has an in-chamber transmission portion disposed below the vehicle compartment floor, and
the heat exchange medium flows in the in-chamber transmission portion, and exchanges heat with air in the vehicle compartment through the vehicle compartment floor.

6. The heating system for a vehicle compartment according to claim 1, wherein
the connection chamber connects to an electric heater disposed in the electric vehicle, and
the heat exchange medium flowing in the connection chamber further exchanges heat with the electric heater.

7. The heating system for a vehicle compartment according to claim 6, wherein the heat exchange medium flowing in the connection chamber exchanges heat with the electric heater, and thereafter exchanges heat with air in the vehicle compartment.

8. The heating system for a vehicle compartment according to claim 6, wherein the electric heater exchanges heat with the heat exchange medium flowing in the connection chamber and thereafter exchanges heat with air in the vehicle compartment.
